(19) United States
(12) Patent Application Publication
(10) Pub. No.: US 2015/0172644 A1
(43) Pub. Date: Jun. 18, 2015

(54) DISPLAY DEVICE AND DISPLAY METHOD THEREOF

(71) Applicant: SAMSUNG DISPLAY CO., LTD., Yongin-City (KR)

(72) Inventor: KYUNG HO JUNG, Seongnam-Si (KR)

(21) Appl. No.: 14/314,855

(22) Filed: Jun. 25, 2014

(30) Foreign Application Priority Data
Dec. 17, 2013 (KR) 10-2013-0157119

(51) Int. Cl. H04N 13/04; G09G 5/00

(52) U.S. Cl. CPC H04N 13/0452; G09G 5/003; H04N 13/0429; G09G 2354/00; G09G 2320/0686

(57) ABSTRACT

A display device is provided. The display device includes a display panel, a signal processor, and a timing controller. A plurality of pixels is disposed on the display panel. The display panel is configured to display left and right eye images. The signal processor is configured to generate and output left eye and right eye image signals. The timing controller is configured to control the display panel the left and right eye images based on the left and right eye image signals outputting from the signal processor. One of the left eye image and the right eye image is a normal image obtained from image information inputting to the signal processor and the other one is a sub image. The sub image is a single color image or a converted image obtained from the normal.

### CROSS-REFERENCE TO RELATED APPLICATION

This application claims priority under 35 U.S.C. §119 to Korean Patent Application No. 10-2013-0157119 filed on Dec. 17, 2013 in the Korean Intellectual Property Office, the disclosure of which is incorporated by reference herein in its entirety.

### TECHNICAL FIELD

The present invention relates to a display device, and more particularly, to a display device and an image display method thereof.

### DISCUSSION OF THE RELATED ART

It is theorized that viewing display devices for extended periods of time may contribute to anisometropia or aggravate anisometropia.

Generally, a case in which an eyesight difference between both eyes is 2 diopters or more is referred to as anisometropia. When a person has anisometropia, the person may depend on the one eye having relatively excellent eyesight and thus, anisometropia may be aggravated.

### SUMMARY

According to an exemplary embodiment of the present invention, a display device is provided. The display device includes a display panel, a signal processor, and a timing controller. A plurality of pixels is disposed on the display panel. The display panel is configured to display a left eye image and a right eye image. The signal processor is configured to generate and to output a left eye image signal and a right eye image signal. The timing controller is configured to control the display panel to display the left eye image and the right eye image based on the left eye image signal and the right eye image signal outputted from the signal processor. One of the left eye image and the right eye image is a normal image obtained from image information inputted to the signal processor and the other one of the left eye image and the right eye image is a sub image. The sub image is a single color image or a converted image obtained from the normal image.

In the display device, the single color image may be a black image or a gray image.

In the display device, the converted image may be a blurred image, a silhouette image, or a luminance-reduced image.

In the display device, the normal image may be displayed during a first period, and the sub image may be displayed during a second period.

In the display device, a length of the first period may be between one minute and one hour.

In the display device, the left eye image may be displayed as the normal image during the first period and may be displayed as the sub image during the second period, and the right eye image may be displayed as the sub image during the first period and may be displayed as the normal image during the second period.

In the display device, both the left eye image and the right eye image may be displayed as the normal image during a third period. The third period may be positioned between the first period and the second period or after the second period.

In the display device, the display device may further include a mode selector. The mode selector may be configured to output a selection signal corresponding to a display mode in which the display device is to be operated among a two-dimensional (2D) mode, a three-dimensional (3D) mode, and an anisometropia mode.

In the display device, the signal processor may be included in the timing controller.

According to an exemplary embodiment of the present invention, a method for displaying an image in a display device is provided. The method includes generating and outputting a left eye image signal and a right eye image signal, controlling an image display of a display panel based on the left eye image signal and the right eye image signal, and displaying a left eye image and a right eye image on the display panel based on the left eye image signal and the right eye image signal. One of the left eye image and the right eye image is a normal image obtained from input image information, and the other one of the left eye image and the right eye image is a sub image. The sub image is a single color image or a converted image obtained from the normal.

In the method, the single color image may be a black image or a gray image, and the converted image may be a blurred image, a silhouette image, or a luminance-reduced image.

In the method, the normal image may be displayed during a first period, and the sub image may be displayed during a second period.

In the method, a length of the first period may be between one minute and one hour.

In the method, the left eye image may be displayed as the normal image during the first period and may be displayed as the sub image during the second period, and the right eye image may be displayed as the sub image during the first period and may be displayed as the normal image during the second period.

In the method, the first period may be longer than the second period, and the first period and the second period may repeat.

In the method, the first period may be shorter than the second period, and the first period and the second period may repeat.

In the method, both the left eye image and the right eye image may be displayed as the normal image during a third period. The third period may be positioned between the first period and the second period or after the second period, and the first to third periods may repeat.

In the method, the length of the first period may be identical to that of the second period, and the first period and the second period may repeat.

According to an exemplary embodiment of the present invention, a display device is provided. The display device includes a display panel and a signal processor. A plurality of pixels is disposed on the display panel. The display panel is configured to display a left eye image and a right eye image. The signal processor is configured to receive image information, and to output a left eye image signal and a right eye image signal for displaying the left eye image and the right eye image. One of the left eye image and the right eye image is displayed as a normal image for a first period and the other one of the left eye image and the right eye image is displayed as a sub image for a second period. The sub image is a version of the normal image that has been modified to be harder to see.

The signal processor may be further configured to display a three-dimensional (3D) image during a 3D mode.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a block diagram of a display device according to an exemplary embodiment of the present invention;

FIG. 2 is a view illustrating an operation of a display device according to an exemplary embodiment of the present invention;

FIG. 3 is a flowchart illustrating a process of generating a main image and a sub image from image information in an anisometropia mode at a display device according to an exemplary embodiment of the present invention;

FIG. 4 illustrates an exemplary lower mode of an anisometropia mode according to an exemplary embodiment of the present invention;

FIG. 5 illustrates an image display method according to an exemplary embodiment of the present invention;

FIG. 6 illustrates an exemplary embodiment of displaying a sub image that is a black image;

FIG. 7 illustrates an exemplary embodiment of displaying a sub image that is a gray image;

FIG. 8 illustrates an exemplary embodiment of displaying a sub image that is a blurred image;

FIG. 9 illustrates an exemplary embodiment of displaying a sub image that is a silhouette image;

FIG. 10 illustrates an exemplary embodiment of displaying a sub image that is a luminance-reduced image;

FIG. 11 illustrates an image display method according to each of exemplary embodiments of FIGS. 7 through 10;

FIG. 12 is a block diagram of a display device according to an exemplary embodiment of the present invention;

Each of FIGS. 13 through 15 is a view illustrating an operation of a display device according to an exemplary embodiment of the present invention;

FIG. 16 illustrates an exemplary embodiment in which a main image and a sub image are displayed using a side-by-side method; and

FIG. 17 illustrates an exemplary embodiment in which a main image and a sub image are displayed using a top-and-bottom method.

### DETAILED DESCRIPTION OF THE EMBODIMENTS

The present invention will be described more fully hereinafter with reference to the accompanying drawings, in which exemplary embodiments of the present invention are shown. However, the present invention may be embodied in various different ways without departing from the spirit or scope of the present invention.

According to an exemplary embodiment of the present invention, a function similar or substantially identical to an eye covering method may be configured in a display device based on a binocular disparity principle. The present invention may be applied to display devices that are designed and operate such that different images (e.g., a left eye image and a right eye image) may be input to both eyes, respectively. The above display device may include a stereoscopic display device using shutter glasses, polarization glasses, or the like, and an auto-stereoscopic display device using a parallax barrier, a lenticular lens, or the like. Exemplary embodiments of the present invention will be initially described in association with a shutter stereoscopic display device and then described in association with another type of a display device.

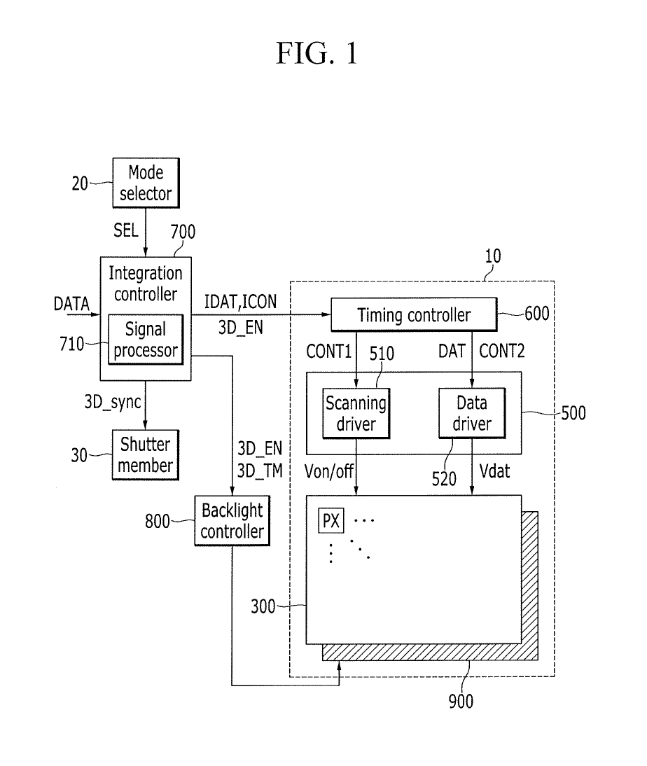

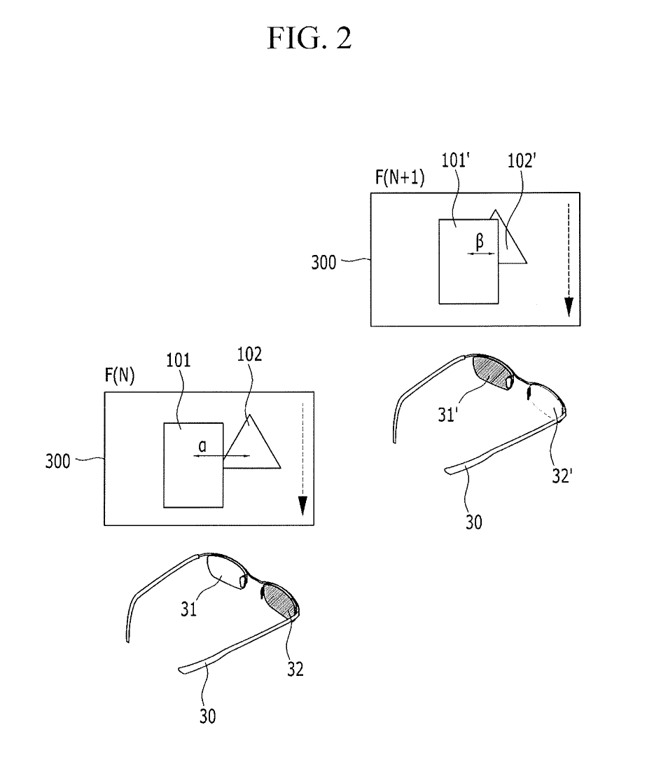

FIG. 1 is a block diagram of a display device according to an exemplary embodiment of the present invention, and FIG. 2 is a view illustrating an operation of a display device according to an exemplary embodiment of the present invention.

Referring to FIG. 1, the display device according to an exemplary embodiment of the present invention may include an integration controller 700, a display assembly 10, a mode selector 20, and a shutter member 30, and may further include a backlight controller 800. The above display device may operate only in an anisometropia mode, or may operate in a three-dimensional (3D) mode as well as the anisometropia mode. The detailed description relating to the anisometropia mode is described later. Hereinafter, an exemplary embodiment of the present invention will be described by using a display device capable of operating in a 3D mode as an example.

The integration controller 700 receives image information DATA from an outside to generate an input image signal IDAT and an input control signal ICON that controls display of the input image signal IDAT. In the case of displaying a stereoscopic image, the integration controller 700 may generate a 3D enable signal 3D_EN, a 3D timing signal 3D_TM, a 3D synchronization signal 3D_sync, or the like. The 3D related signals (e.g., 3D enable signal 3D_EN, 3D timing signal 3D_TM, and 3D synchronization signal 3D_sync) may be generated and used when the display device operates in the anisometropia mode and the 3D mode.

The integration controller 700 includes a signal processor 710 configured to generate the input image signal IDAT. The signal processor 710 may generate the input image signal IDAT that matches the 3D mode, a two-dimensional (2D) mode, or the anisometropia mode, based on a selection signal SEL input from the mode selector 20. Hereinafter, the input image signals are referred to as a 3D image signal, a 2D image signal, and an anisometropia image signal, respectively. Each of the 3D image signal and the anisometropia image signal includes a left eye image signal and a right eye image signal.

Depending on exemplary embodiments of the present invention, the signal processor 710 may be separately positioned at an outside of the integration controller 700, or may be positioned within another device, for example, a timing controller 600. Depending on exemplary embodiments of the present invention, an image processor configured to generate the 3D image signal or the 2D image signal and an image processor configured to generate the anisometropia image signal may be separately present.

The integration controller 700 may transfer the input image signal IDAT, the 3D enable signal 3D_EN, the input control signal ICON, or the like to the timing controller 600 of the display assembly 10, may transfer the 3D enable signal 3D_EN and the 3D timing signal 3D_TM to the backlight controller 800, and may transfer the 3D synchronization signal 3D_sync to the shutter member 30.

The input image signal IDAT contains luminance information. Luminance may have a predetermined number of gray levels, for example, 1024=210, 256=2⁸, or 64=2⁶ grays. The 3D enable signal 3D_EN instructs the display device to operate in the 3D mode, and the 3D timing signal 3D_TM may contain timing information of a plurality of driving signals based on the 3D mode. The 3D synchronization signal 3D_sync is a signal capable of controlling an on/off timing of a shutter included in the shutter member 30 based on the 3D mode. The input control signal ICON may include a vertical synchronization signal Vsync and a horizontal synchronizing signal Hsync, a main clock MCLK, a data enable signal DE, or the like, in association with an image display.

The display assembly 10 according to an exemplary embodiment of the present invention includes a display panel 300 configured to display an image, a driver 500 including a gate driver 510 and a data driver 520, the timing controller 600 configured to control the driver 500, and a backlight unit 900 configured to supply light to the display panel 300.

The display panel 300 of the display assembly 10 may be a display panel included in one of various display devices such as a liquid crystal display (LCD) device, an organic light emitting device (OLED), a plasma display device, an electrophoretic display device, or the like.

From view of an equivalent circuit, the display panel 300 includes a plurality of display signal lines and a plurality of pixels PX connected thereto. The plurality of pixels PX may be arranged in a matrix. The plurality of display signal lines includes a plurality of gate lines (not shown) configured to transfer a gate signal (referred to as a “scanning signal”) and a plurality of data lines (not shown) configured to transfer a data signal. Each pixel PX may include a corresponding gate line, a switching element (not shown), such as a thin film transistor, connected thereto, a pixel electrode (not shown) connected thereto, and a common electrode (not shown) configured to face the pixel electrode. Each pixel PX includes an electro-optical active layer positioned between the pixel electrode and the common electrode. The electro-optical active layer is a portion configured to convert an electrical signal to an optical signal. For example, an LCD panel may include a liquid crystal layer as the electro-optical active layer, and an OLED panel may include an organic light emission layer. The display panel 300 may display a left eye image and a right eye image by the entire pixels or a combination of pixels.

The timing controller 600 controls an operation of the driver 500 including the gate driver 510, the data driver 520, or the like. The timing controller 600 may operate in the 2D mode, the 3D mode, or the anisometropia mode, based on the 3D enable signal 3D_EN received from the integration controller 700. All of the operation of the timing controller 600 may be identical in the 3D mode and the anisometropia mode in which the left eye image and the right eye image are displayed. The timing controller 600 appropriately processes the input image signal IDAT to be suitable for an operating condition of the display panel 300, based on the input image signal IDAT and the input control signal ICON, generates a gate control signal CONT1 and a data control signal CONT2, transmits the gate control signal CONT1 to the gate driver 510, and transmits the data control signal CONT2 and the processed image signal DAT to the data driver 520.

The data driver 520 is connected to the data line of the display panel 300 to generate gray voltages with respect to the entire grays by using a gray reference voltage received from a gray voltage generator (not shown). The data driver 520 may receive a plurality of gray voltages from the gray voltage generator. The data driver 520 receives the image signal DAT corresponding to a single row of pixels PX (referred to as a “pixel row”) based on the data control signal CONT2, selects a gray voltage corresponding to each image signal DAT from the gray voltages, converts the image signal DAT to a data voltage Vdat, and applies the converted data voltage Vdat to the corresponding data line. In the 3D mode and the anisometropia mode, the data voltage Vdat may include a left eye data voltage and a right eye data voltage.

The gate driver 510 is connected to the gate line to apply, to the gate line, a gate signal including a combination of a gate-on voltage Von and a gate-off voltage Voff. The gate driver 510 applies the gate-on voltage Von to the gate line based on the gate control signal CONT1 transmitted from the timing controller 600 to turn on the switching element connected to the gate line. In addition, the data voltage Vdat applied to the data line may be applied to a corresponding pixel PX via the turned-on switching element.

The backlight unit 900 may be positioned at the back of the display panel 300 and includes a light source. An example of the light source includes a light emitting diode (LED), a cold cathode fluorescent lamp, or the like. The backlight unit 900 may be included in a non-emissive display device such as an LCD device and an electrophoretic display device. In the case of an emissive display device such as an OLED and a plasma display device, the backlight unit 900 and a constituent element (e.g., a backlight controller) associated with the emissive display device may be omitted.

The display assembly 10 may display an image of a single frame by sequentially applying the gate-on voltage Von to all of the gate lines by using a 1 horizontal period (also written as “1H” and identical to a single period of the horizontal synchronizing signal Hsync and the data enable signal DE) as a unit, and by applying the data voltage Vdat to all of the pixels PX. In the 3D mode or the anisometropia mode, a single frame may be a time in which a left eye data voltage is applied to all of the pixels PX or a right eye data voltage is applied to all of the pixels PX. In addition, a vertical blank VB may be inserted between a frame in which the left eye data voltage is applied and a frame in which the right eye data voltage is applied. Each vertical blank VB may continue during substantially the same period of time as the frame in which the left eye data voltage or the right eye data voltage is applied.

The backlight controller 800 receives the 3D timing signal 3D_TM, the 3D enable signal 3D_EN, or the like from the integration controller 700, generates a backlight control signal based thereon, and transmits the generated backlight control signal to the backlight unit 900. The backlight controller 800 may receive a control signal from the timing controller 600. The backlight unit 900 may be turned on or turned off during a predetermined period of time according to a control of the backlight control signal.

The mode selector 20 transmits the selection signal SEL to the integration controller 700. The selection signal SEL corresponds to a display mode in which the display device is to be operated among display modes such as the 2D mode, the 3D mode, and the anisometropia mode. Depending on exemplary embodiments of the present invention, the mode selector 20 may be provided to determine only whether to operate the display device in the anisometropia mode. The 2D mode and the 3D mode may be automatically set when a viewer does not select the anisometropia mode. For example, when image information DATA includes depth information, the display device may operate in the 3D mode. When the image information DATA does not include the depth information, the display device may operate in the 2D mode. The mode selector 20 may also be positioned at an outside of the display device.

The mode selector 20 may be provided as a predetermined menu in a product, for example, a monitor, a television, a mobile phone, or the like, and thus, the viewer may easily select the desired mode. Here, the 2D mode refers to a mode in which there is no discrimination between a left eye image and a right eye image, or a mode in which the left eye image and the right eye image are identical to each other and are displayed without the disparity between the two images (e.g., the left and right images). The 3D mode refers to a mode in which the left eye image and the right eye image express the substantially identical image, but are displayed to have the disparity between the two images (e.g., the left and right images) and thus, the viewer is enabled to perceive a 3D effect. Accordingly, when the left eye image and the right eye image do not mach with each other and the two images are placed to overlap in the 3D mode, positions or sizes of objects in the two images may differ from each other.

The anisometropia mode may be a mode in which one of the left eye image and the right eye image is displayed as an image (hereinafter, referred to as a “normal image”) obtained from image information and the other one of the left eye image and the right eye image is displayed as a single color image. For example, the anisometropia mode may be a mode in which one of the left eye image and the right eye image is displayed as the normal image and the other one of the left eye image and the right eye image is displayed as a converted image having no disparity with the normal image. Here, the single color image may be an achromatic color such as black or gray. For example, the converted image may be an image obtained by blurring the normal image. The converted image may be an image indicating the silhouette of the normal image. The converted image may be an image obtained by lowering luminance of the normal image. However, the present invention is not limited thereto. The converted image includes an image obtained by processing the normal image to be seen further unclearly.

Hereinafter, the normal image is referred to as a “main image”, and the single color image or the converted image excluding the normal image is referred to as a “sub image”. In the anisometropia mode, one of the left eye image and the right eye image may be the main image and the other one may be the sub image. Depending on exemplary embodiments of the present invention, even in the anisometropia mode, all of the left eye image and the right eye image may be the main images.

For example, the anisometropia mode may include a right eye main view mode, a left eye main view mode, a self-diagnosis mode, or the like. One of the above modes may be selected. Here, the right eye main view mode refers to a display mode in which when the eyesight of the right eye is relatively poor, a main image is allocated to the right eye image to be relatively long in time and a sub image is allocated to the left eye image to be relatively short in time, so that the right eye is more frequently used and the left eye is less frequently used. The left eye main view mode refers to a display mode in which when the eyesight of the left eye is relatively poor, a main image is allocated to the left eye image to be relatively long in time and a sub image is allocated to the right eye image to be relatively short in time, so that the left eye is more frequently used and the right eye is less frequently used. The self-diagnosis mode may refer to a display mode in which the viewer may recognize an eyesight difference between both eyes. To this end, the display device may display the main image and the sub image using the left eye (or right eye) image and the right eye (or left eye) image, respectively, during a first predetermined period of time. In addition, the display device may display the main image and the sub image using the right eye (or left eye) image and the left eye (or right eye) image, respectively, during a second predetermined period of time. In the self-diagnosis mode, the sub image may be a black image and thus, the eyesight difference may be more easily recognized.

The anisometropia mode may include a lower mode, such as a main/sub image switching period setting mode and a sub image processing mode. Here, the main/sub image switching period setting mode refers to a mode capable of setting a first period and a second period. For example, during the first period, the main image and the sub image may be displayed using the left eye image (or the right eye image) and the right eye image (or the left eye image), respectively, in each main view mode, and during the second period, the main image and the sub image may be switched and thus, the main image and the sub image may be displayed using the right eye image (or the left eye image) and the left eye image (or the right eye image), respectively. The first period may temporally precede the second period, or vise versa. The sub image processing mode refers to a mode for, for example, determining whether to display a single color image as the sub image or whether to display a converted image as the sub image, or a mode for further selecting, as the sub image, any one image from among a black image, a gray image, a blurred image, a silhouette image, a luminance-reduced image, or the like.

The shutter member 30 may receive the 3D synchronization signal 3D_sync from the integration controller 700 and may open or close a shutter. Accordingly, the 3D synchronization signal 3D_sync may control on/off timing of the shutter and on/off maintaining time of the shutter, or the like. In addition, the 3D synchronization signal 3D_sync may be generated by the timing controller 600 and may be transferred to the shutter member 30. Accordingly, the shutter member 30 may be synchronized with the display assembly 10. Through on/off of a left eye shutter and a right eye shutter of the shutter member 30, the viewer may three-dimensionally recognize an image displayed by the display assembly 10.

As illustrated in FIG. 2, the shutter member 30 according to an exemplary embodiment of the present invention may be shutter glasses including a left eye shutter 31 or 31′ and a right eye shutter 32 or 32′. The above shutter glasses may include machine type shutter glasses (e.g., goggles), optical shutter glasses, shutter glasses including a head mount and a shutter using a micro electromechanical system (MEMS), or the like.

An operation principle of a display device according to an exemplary embodiment of the present invention will be described with reference to FIGS. 1 and 2.

Referring to FIG. 2, an arrow direction illustrated in the display panel 300 indicates an order in which a gate-on voltage Von is applied to a plurality of gate lines extended in a direction (e.g., row direction) substantially perpendicular to the arrow direction. For example, the gate-on voltage Von may be sequentially applied to the plurality of gate lines starting from the first gate line of the display panel 300 to the last gate line thereof.

According to an exemplary embodiment of the present invention, the shutter member 30 may include, as shutter glasses, the left eye shutter 31 or 31′ and the right eye shutter 32 or 32′. When the display panel 300 alternately displays left eye images 101 and 102 and right eye images 101′ and 102′ using, for example, a frame segmentation method that is a time division method, the right eye shutters 32 and 32′ and the left eye shutters 31 and 31′ of the shutter members 30 are synchronized therewith to alternately block light corresponding to the left eye images 101 and 102 or the right eye images 101′ and 102′. The left eye shutter 31 or 31′ may be the left eye shutter 31 in an open state or the left eye shutter 31′ in a closed state, and the right eye shutter 32 or 32′ may be the right eye shutter 32 in the closed state or the right eye shutter 32′ in the open state. For example, in an N-th frame F(N), when the left eye shutter 31 is in the open state, the right eye shutter 32 may be in the closed state. In an (N+1)-th frame F(N+1), when the left eye shutter 31′ is in the closed state, the right eye shutter 32′ may be in the open state. However, the present invention is not limited thereto. For example, based on a display mode, all of the left eye shutter 31 and the right eye shutter 32 may be in the open state, or may be in the closed state.

When the left eye images 101 and 102 are displayed on the display panel 300, the left eye shutter 31 of the shutter member 30 enters into the open state in which light is transmitted and the right eye shutter 32 enters into the closed state in which the light is blocked. When the right eye images 101′ and 102′ are displayed on the display panel 300, the right eye shutter 32′ of the shutter member 30 enters into the open state in which light is transmitted and the left eye shutter 31′ enters into the closed state in which the light is blocked. Accordingly, a left eye image may be recognized only by the left eye during a predetermined period of time and a right eye image may be recognized only by the right eye only during a subsequent period of time.

In a 3D mode, the left eye images 101 and 102 and the right eye images 101′ and 102′ may have a disparity therebetween. Due to the disparity between the two images, the brain of a human may perceive a 3D effect. In an anisometropia mode, one of the left eye images 101 and 102 and the right eye images 101′ and 102′ may be a main image that is a normal image, and the other one may be a sub image that is an achromatic or a converted image. A viewer may depend on an eye into which the main image is input between the both eyes to view a displayed image.

Hereinafter, an operation of an anisometropia mode in a display device according to an exemplary embodiment of the present invention will be described in detail.

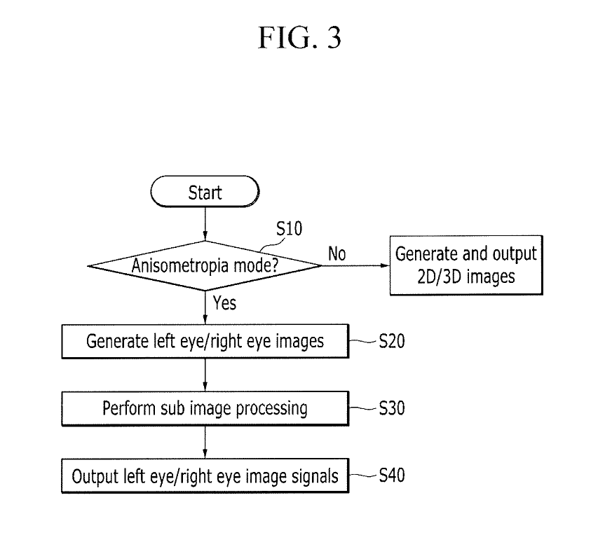

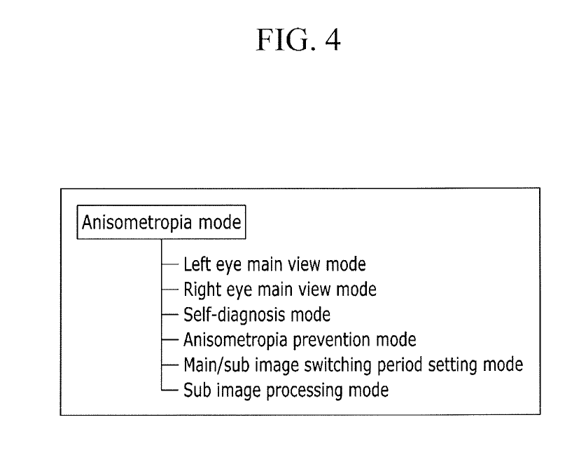

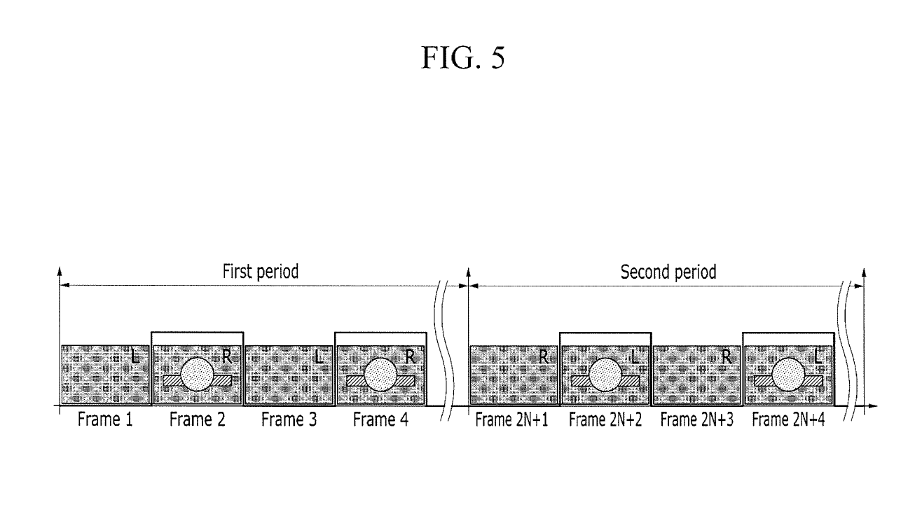

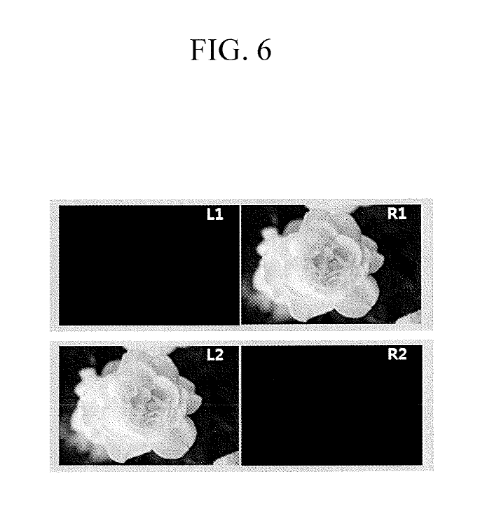

FIG. 3 is a flowchart illustrating a process of generating a main image and a sub image from image information in an anisometropia mode at a display device according to an exemplary embodiment of the present invention, FIG. 4 illustrates an exemplary lower mode of an anisometropia mode according to an exemplary embodiment of the present invention, and FIG. 5 illustrates an image display method according to an exemplary embodiment of the present invention.

Referring to FIGS. 1 and 3, when image information DATA is input, the signal processor 710 processes the image information DATA based on a selected display mode or a display mode set as default, generates the input image signal IDAT appropriate for the corresponding display mode, and transmits the input image signal IDAT to the timing controller 600. For example, when the display mode is a 2D or a 3D mode, the signal processor 710 generates a 2D image signal or a 3D image signal and outputs the 2D image signal or the 3D image signal according to a 2D or 3D image signal generation method.

When the display mode is determined as the anisometropia mode by a selection of a viewer or the like (S10), the signal processor 710 generates a left eye image and a right eye image from image information (S20). In this instance, the left eye image and the right eye image are normal images and are substantially identical to each other. A method of discriminating the left eye image and the right eye image may use any of a frame segmentation method such as a sequential frame, a side-by-side method, and a top-and-bottom method, and an interlace method such as a checker boarder. However, a discrimination method is not limited thereto and known discrimination methods may be used. Even though an anisometropia mode is executed in a display device capable of performing a 3D display, a 3D effect is not aimed and thus, the disparity is absent between a left eye image and a right eye image generated in the anisometropia mode. When the generated left eye image and right eye image are output as image signals, the display device may display a planar image having no perception of depth.

Further, sub image processing is performed on one of the left eye image and the right eye image (S30). Here, sub image processing indicates rendering a normal image into a sub image defined as described above. For example, sub image processing may convert the normal image into a single color image such as black or gray, or may convert the normal image as a blurred image, a silhouette image, or a luminance-reduced image. A main image is generated to force a viewer to use an eye having better eyesight less and to use an eye having poorer eyesight more.

When sub image processing is performed, the signal processor 710 outputs the left eye image signal and the right eye image signal (S40). Here, one of the left eye image signal and the right eye image signal corresponds to the main image and the other one correspond to the sub image. For example, when the sub image processing is performed on the left eye image, the signal processor 710 outputs a main image signal that is the normal image, using the left eye image, and outputs a sub image signal using the right eye image.

An image to be sub image processed between the left eye image and the right eye image may be determined based on a lower mode of the anisometropia mode. An operation in the lower mode will be described with reference to FIGS. 4 and 5.

Referring to FIG. 4, the anisometropia mode may include, as lower modes, a left eye main view mode, a right eye main view mode, a self-diagnosis mode, and an anisometropia prevention mode, and may further include a main/sub image switching period setting mode and a sub image processing mode. Depending on exemplary embodiments of the present invention, the main/sub image switching period setting mode and/or the sub image processing mode may also be included as the lower modes of the left eye main view mode and the right eye main view mode.

For example, when the eyesight of the right eye of a viewer is relatively poor, the viewer may select the right eye main view mode to use the right eye more frequently and use the left eye less frequently. In this case, the signal processor 710 may perform sub image processing on the left eye image during a first period in operation S30 and may perform sub image processing on the right eye image during a second period. As a result, the sub image may be displayed using the left eye image during the first period and the sub image may be displayed using the right eye image during the second period. The first period and the second period may repeat, and the second period may precede the first period. Depending on exemplary embodiments of the present invention, a third period during which sub image processing is not performed on all of the left eye image and the right eye image may be present between the first period and the second period and/or after the second period, and the first to third periods may repeat. Accordingly, the main image may be displayed using both of the left eye image and the right eye image during the third period. The second period and/or the third period may prevent fatigues from being accumulated on one eye or preventing the eyesight of the other eye from being degraded when viewing an image for long hours through the one eye.

Referring to FIG. 5 illustrating an example in which a sub image is a black image. For example, when a right eye main view mode is selected, a left eye image that is a black image is displayed in, for example, odd numbered frames (e.g., Frame 1, 3, . . . , 2N+1, 2N+3, . . . ), and a right eye image that is a main image is displayed in even numbered frames (e.g., Frame 2, 4, . . . , 2N+2, 2N+4, . . . ). The displayed image may be an image or a motion picture. During a first period, the left eye image is the sub image that is the black image and the right eye image is the main image that is the normal image. During a second period, the left eye image is the main image that is the normal image and the right eye image is the sub image that is the black image. For example, to increase an amount of time for using the right eye, the first period may be set to be longer than the second period. The first period and the second period may be set within the range of a few seconds to a few hours, and the first period and the second period may repeat. The first period and the second period may be set in the main/sub image switching period setting mode. The black image may be set in the sub image processing mode. In FIG. 5, a solid line such as a square wave is intended to indicate relative luminance of the main image and the sub image.

Even though FIG. 5 illustrates that the first period during which the left eye image is the sub image initially starts in the right eye main view mode, the second period during which the right eye image is the sub image may initially start. Even in this case, the first period may be set to be longer than the second period. Depending on exemplary embodiments of the present invention, the second period during which the right eye image is displayed as the sub image may be absent in the right eye main view mode, the third period during which all of the left eye image and the right eye image are displayed as the main image may be present between the first period and the second period and/or after the second period, and the first to third periods may repeat.

Compared to the right eye main view mode, the left eye main view mode differs in that a period during which sub image processing is performed on the left eye image is relatively longer than a period during which sub image processing is performed on the right eye image, and is substantially identical in other terms. Accordingly, when the viewer selects the left eye main view mode, the left eye image and the right eye image may be displayed to be contrary to those in the right eye main view mode. For example, by performing sub image processing on the right eye image during the first period and by performing sub image processing on the left eye image during the second period, the sub image is displayed using the right eye image during the first period and the sub image is displayed using the left eye image during the second period. In this instance, to force the viewer to more use the left eye having relatively poor eyesight, the first period may be set to be longer than the second period. Depending on exemplary embodiments of the present invention, the second period may initially start prior to the first period, or the second period may be absent. The third period may be present between the first period and the second period and/or after the second period, and the first to third periods may repeat. The first period and the second period may be set in the main/sub image switching period setting mode.

By enabling the viewer to more frequently use an eye having relatively poor eyesight between the left eye and the right eye through the right eye main view mode and the left eye main view mode, substantially the same effect as an eye covering method of enabling the viewer to use the eye having relatively poor eyesight while covering the other eye having relatively excellent eyesight may be achieved. In the case of setting a main/sub image switching period setting mode, for example, when there is a prescription of a doctor about a covering treatment, the switching period thereof may be set according to instructions of the prescription. For example, in the right eye main view mode or the left eye main view mode, the first period, the second period, and the third period may be set as 60 seconds/20 seconds/30 seconds, respectively, 2 minutes/30 seconds/1 minute, respectively, 1 hour/2 minutes/10 minutes, respectively, or the like. For example, a length of the first period may be between 60 seconds and 1 hour.

The right eye main view mode and the left eye main view mode may be executed in a work (e.g., a documentation work) using a monitor or a natural view environment such as viewing of image contents (e.g., a movie, news, web surfing). A separately generated image might not be required for the anisometropia mode. In addition, the normal image may be input through one eye and the single color image or a blurred image may be input through the other eye. The single color image might not significantly obstruct recognition of the normal image. The image inputting through the other eye may include an image of which luminance is converted to be low image compared to the normal image is input. Accordingly, the viewer may substantially recognize the normal image. The aforementioned matters are similar even in the self-diagnosis mode or the anisometropia prevention mode, which are described hereinafter.

When the self-diagnosis mode is selected, the signal processor 710 may perform sub image processing on the left eye image (or the right eye image) during, for example, the first period, and may perform sub image processing on the right eye image (or the left eye image) during the second period in operation S30. Accordingly, the sub image is input to the left eye (or the right eye) of the viewer during the first period and the main image is input to the right eye (or the left eye) during the second period. The main image is input to the right eye (or the left eye) during the first period and the sub image is input during the second period. Accordingly, when an eyesight difference capable of causing anisometropia is present between the left eye and the right eye, the viewer may perceive a difference in resolution and luminance between an image recognized during the first period and an image recognized during the second period. Accordingly, through the self-diagnosis mode, the viewer may become aware of whether anisometropia is present. To maximize the contrast between the left eye image and the right eye image, the sub image may be the black image. In the self-diagnosis mode, corresponding information may be displayed on a screen as subtitles so that the viewer may become aware of with which eye the viewer is viewing the main image. In the self-diagnosis mode, the first period and the second period may be set within the range of a few seconds to a few minutes.

The anisometropia prevention mode is a display mode for enabling the viewer to regularly use both eyes in turn. In the anisometropia prevention mode, the signal processor 710 performs sub image processing on one of the left eye image and the right eye image during the first period, and performs sub image processing on the other image during the second period. Lengths of the first period and the second period may be substantially identical to each other, and may be set within the range of a few seconds to a few minutes. The anisometropia prevention mode might not exist as a separate mode and may be configured by setting lengths of the first period and the second period to be identical to each other or substantially identical to each other in the right eye main view mode or the left eye main view mode.

The aforementioned exemplary embodiment of the present invention describes that the signal processor 710 operates to generate the left eye image and the right eye image, performs sub image processing on one of the left eye image and the right eye image based on a lower mode, and outputs a left eye image signal and a right eye image signal. However, depending on exemplary embodiments of the present invention, the signal processor 710 may operate to generate two identical normal images from image information, to perform sub image processing one of the two identical normal images, and to output the left eye image as the main image and output the right eye image as the sub image, or to output the right eye image as the main image and output the left eye image as the sub image based on the lower mode.

In addition, when the sub image is a single color image such as a black image, the single color image does not express a shape and thus, the disparity itself is absent between the sub image and the normal image. Accordingly, in this case, the signal processor 710 may operate to generate a single normal image based on image information and to generate a single color image in addition thereto, and may output one of the single normal image and the single color image as a left eye image signal and output the other one of the single normal image and the single color image as a right eye image signal based on a lower mode of the anisometropia mode.

Hereinafter, the anisometropia mode based on a type of a sub image will be described with reference to FIGS. 6 through 11.

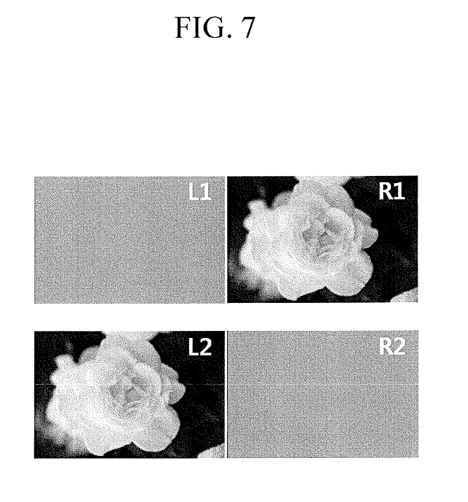

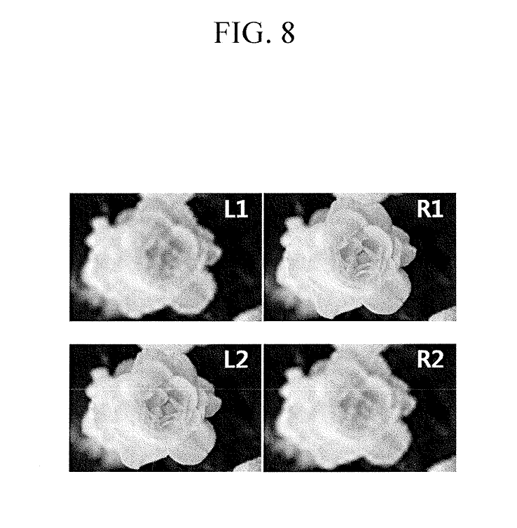

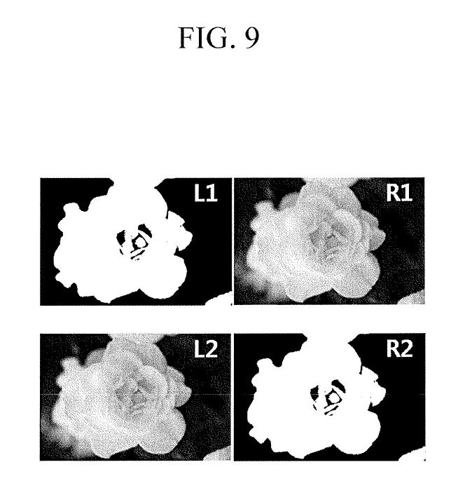

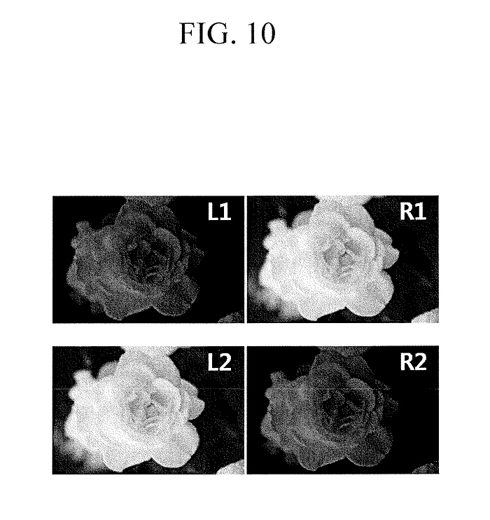

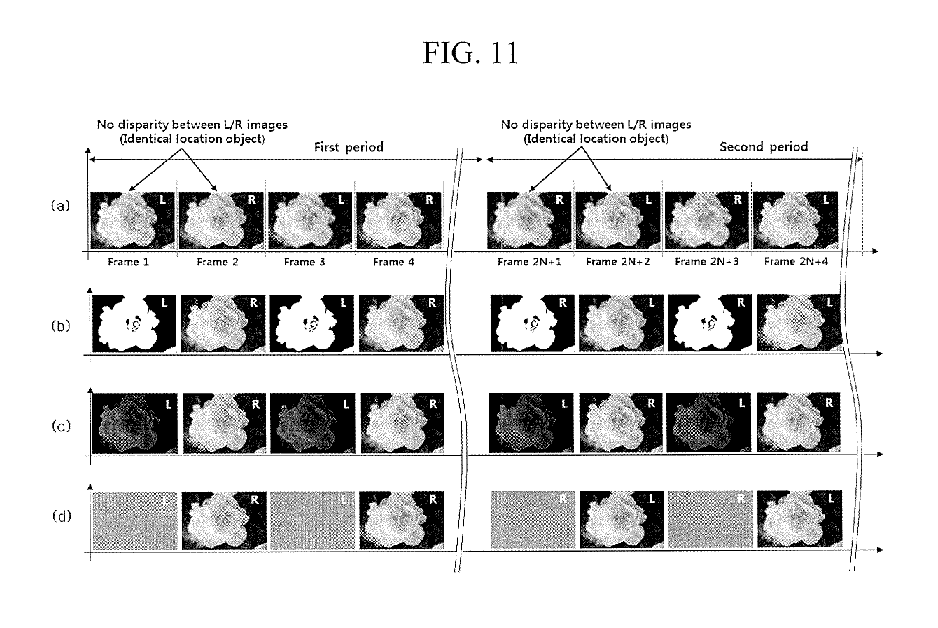

FIG. 6 illustrates an exemplary embodiment of displaying a sub image that is a black image, FIG. 7 illustrates an exemplary embodiment of displaying a sub image that is a gray image, FIG. 8 illustrates an exemplary embodiment of displaying a sub image that is a blurred image, FIG. 9 illustrates an exemplary embodiment of displaying a sub image that is a silhouette image, FIG. 10 illustrates an exemplary embodiment of displaying a sub image that is a luminance-reduced image, and FIG. 11 illustrates an image display method according to an exemplary embodiments of the present invention.

In FIGS. 6 through 10, between two images of an upper side, a left eye image L1 is a sub image and a right eye image R1 is a main image. Between two images of a lower side, a left eye image L2 is a main image and a right eye image R2 is a sub image. The left eye image L1 and the right eye image R1 of the upper side are images generated based on the same image information and having no disparity therebetween. The left eye image L1 is sub image processed, and the left eye image L1 and the right eye image R1 are alternately displayed using a frame segmentation method. The left eye image L2 and the right eye image R2 of the lower side are images generated based on the same image information and having no disparity therebetween. The right eye image R2 is sub image processed and the left eye image L2 and the right eye image R2 are alternately displayed using the frame segmentation method. By setting a period to be indicated on the upper side of each drawing and a period to be indicated on the lower side of each drawing, the anisometropia mode may be set to any one of a right eye main view mode, a left eye main view mode, a self-diagnosis mode, or the like.

FIG. 6 illustrates an example in which a sub image is a black image. When the sub image is the black image, the black image is input to one eye of a viewer and a normal image is input to the other eye of the viewer during a predetermined period. The viewer depends on the eye to which the normal image is input to recognize an image and thus, a covering effect of substantially covering the eye to which the black image is input may be achieved.

Similar to the example of FIG. 6, FIG. 7 illustrates an example in which the sub image is a gray image that is an achromatic image. Compared to a case in which the sub image is the black image, the luminance of a recognized image may be less reduced. For example, when the gray image is set to have an average gray value of the main image, a change in luminance of the recognized image may be minimized. As illustrated in (d) of FIG. 11, the left eye image may be a gray image and the right eye image may be a normal image during a first period, and the right eye image may be a gray image and the left eye image may be a normal image during a second period. The gray image does not substantially display an image and thus, the viewer may recognize an image by depending on the eye to which the normal image is input. Accordingly, a covering effect may be achieved.

FIG. 8 illustrates an example in which the sub image is a blurred image. The blurred image may be an image of which resolution is reduced using, for example, a known resolution conversion method. As described above, the disparity is absent between the main images R1 and L2 and the sub images L1 and R2. Referring to (a) of FIG. 11, the left eye image may be a blurred image and the right eye image may be a normal image during the first period, and the right eye image may be a blurred image and the left eye image may be a normal image during the second period. When the first period is longer than the second period, a corresponding mode may be a right eye main view mode. When the first period is shorter than the second period, the corresponding mode may be a left eye main view mode. When the first period is identical to the second period, the corresponding mode may be an anisometropia prevention mode. The viewer recognizes an image by depending on the vivid normal image rather than the blurred image and thus, more frequently uses the eye to which the normal image is input and less frequently uses the eye to which the blurred image is input. Accordingly, a covering effect may be substantially achieved.

FIG. 9 illustrates an example in which the sub image is a silhouette image, and FIG. 10 illustrates an example in which the sub image is a luminance-reduced image. The disparity is absent between the main images R1 and L2 and the sub images L1 and R2. As illustrated in (b) and (c) of FIG. 11, the main image may be input to one of the left eye and the right eye, and the sub image may be input to the other one during a predetermined period. When viewing an image, the viewer further depends on the eye to which the main image that is the normal image is input. Accordingly, the covering effect may be substantially achieved.

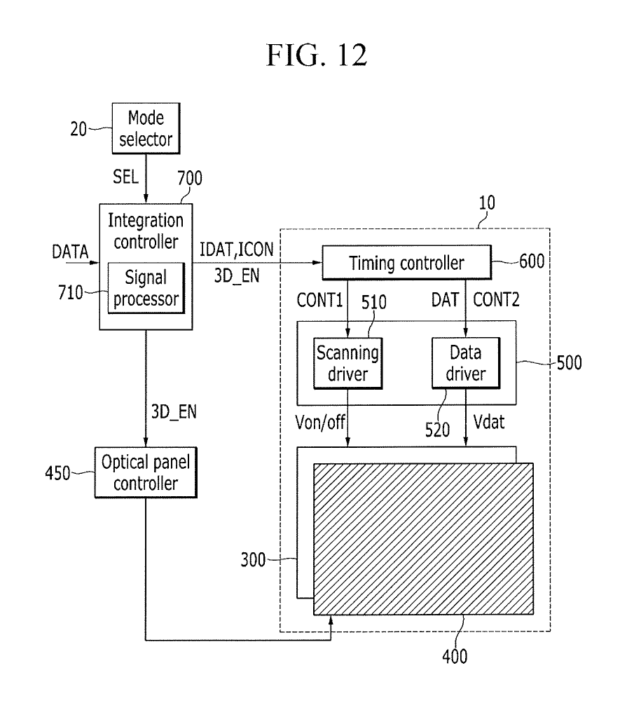

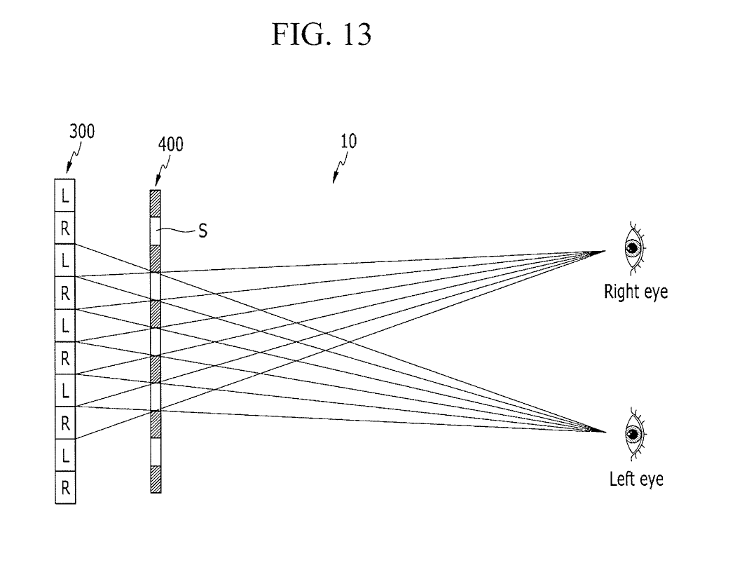

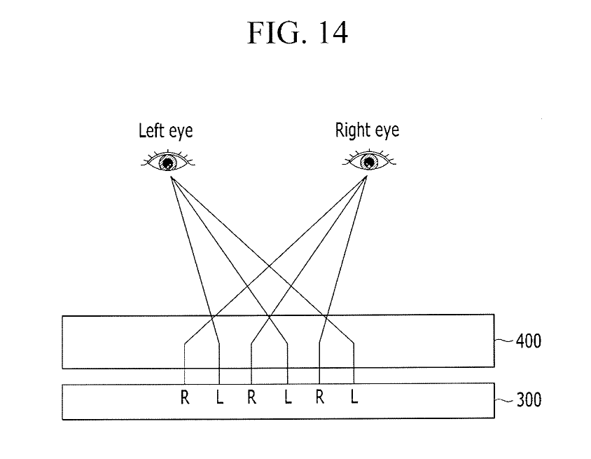

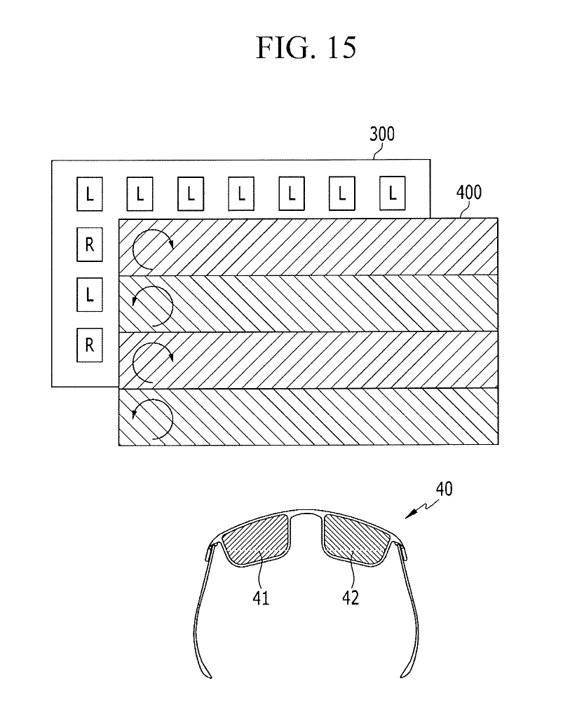

FIG. 12 is a block diagram of a display device according to an exemplary embodiment of the present invention, and each of FIGS. 13 through 15 is a view illustrating an operation of a display device according to an exemplary embodiment of the present invention.

FIG. 12 illustrates an exemplary embodiment of an autostereoscopic display device or a polarization stereoscopic display device. A description is made based on a difference between the exemplary embodiment of FIG. 12 and the exemplary embodiment of FIG. 1. Dissimilar to the shutter stereoscopic display device of FIG. 1, the autostereoscopic display device does not include a shutter member and instead, includes an optical panel 400 in front of the display panel 300.

The optical panel 400 is a device configured to change a path of light so that an image displayed on the display panel 300 may be recognized as a stereoscopic image. For example, light emitted from the display panel 300 is refracted or diffracted when passing through the optical panel 400 whereby a progress direction of the light is changed. In addition, 2D images having the disparity may be respectively input to the left eye and the right eye of the viewer who is positioned at the intended viewpoint or wearing polarization glasses whereby a stereoscopic image having the perception of depth may be recognized.

The optical panel 400 may be a panel based on a parallax barrier (hereinafter, referred to as a “barrier”) method of FIG. 13 or a panel of a lenticular lens method of FIG. 14, however, is not limited thereto. The optical panel 400 may be a N/4 patterned retarder of FIG. 15.

The optical panel 400 may be an optical panel switchable between a 3D mode for displaying a 3D image and a 2D mode for displaying a 2D image, so that the display device may display the 3D image as well as the 2D image. In this case, the display device may include an optical panel controller 450 configured to control the optical panel 400. The optical panel controller 450 may apply, to a signal line (not shown) connected to the optical panel 400, a control signal for operating the optical panel 400 in the 3D mode or the anisometropia mode in response to an input of a 3D enable signal 3D_EN.

The display device, for example, the signal processor 710 may generate and output a left eye image and a right eye image. A method of discriminating the left eye image and the right eye image may be an interlace method. However, even in the case of the autostereoscopic display device or the polarization stereoscopic display device, a frame segmentation method or an interlace method and a frame segmentation method may be simultaneously used.

Referring to FIG. 13, a parallax barrier method enables an image from the display panel 300 to be divided into a left eye image L and a right eye image R via a slit S in the optical panel 400 in which the slit S is formed on a barrier, thus enabling the left eye image L and the right eye image R to be input to the left eye and the right eye of the viewer, respectively. When the above two images (e.g., left and right eye images L and R) are transferred to the brain through the retina of the viewer, and thus, the viewer may perceive the perception of depth and reality of a stereoscopic image. When the display device operates in the anisometropia mode, the disparity is absent between the left eye image L and the right eye image R. One of the left eye image L and the right eye image R may be a sub image such as a single color image, an image converted based on a normal image, or the like.

Referring to FIG. 14, the display device using a lenticular lens displays a left eye image L and a right eye image R on the display panel 300, and changes a path of light using lenses arranged on the optical panel 400, thus enabling an image from the display panel 300 to be divided into the left eye image L and the right eye image R and to be input to the left eye and the right eye of the viewer, respectively. When the disparity is present between the left eye image L and the right eye image R, the viewer may perceive a 3D effect. Similar to a different type of a display device, when the display device operates in the anisometropia mode, the disparity is absent between the left eye image L and the right eye image R. One of the left eye image L and the right eye image R may be a sub image such as a single color image, an image converted based on a normal image, or the like.

Referring to FIG. 15, in a polarization stereoscopic display device, polarizers (not shown) of which transmissive axes vertically intersect are, for example, attached on both surfaces of the display panel 300. The optical panel 400 that is a λ/4 patterned retarder is to have a phase difference of λ/4 with respect to the incident light. For example, the optical panel 400 enables light (for example, for displaying a left eye image L) from odd numbered pixel rows of the display panel 300 to be in a right-circular polarization state and enables light (for example, for displaying a right eye image R) from an even numbered pixel rows of the display panel 300 to be in a left-circular polarization state. A λ/4 phase film configured to change the right-circularly polarized light to a linear polarization and a λ/4 phase film configured to change the left-circularly polarized light to a linear polarization are attached to a left eye portion 41 and a right eye portion 42 of the polarization glasses 40 constituting a set with the above display device, respectively. Accordingly, the viewer views the left eye image L displayed by the odd numbered pixel rows via the left eye portion 41 of the polarization glasses 40 and views the right eye image R displayed by the even numbered pixel rows via the right eye portion 42 of the polarization glasses 40. In the 3D mode, the disparity is present between the left eye image L and the right eye image R and thus, the viewer may perceive a 3D effect. In the anisometropia mode, the disparity is absent between the left eye image L and the right eye image R. One of the left eye image L and the right eye image R may be a sub image such as a single color image, an image converted based on a normal image, or the like.

Hereinafter, an exemplary embodiment of displaying a sub image in a display device configured to discriminate a left eye image and a right eye image using an interlace method will be described.

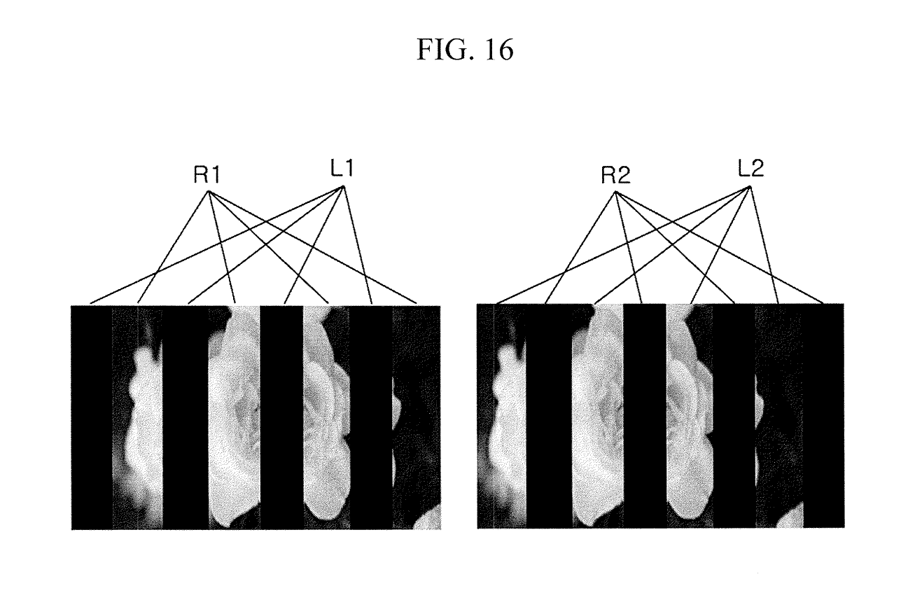

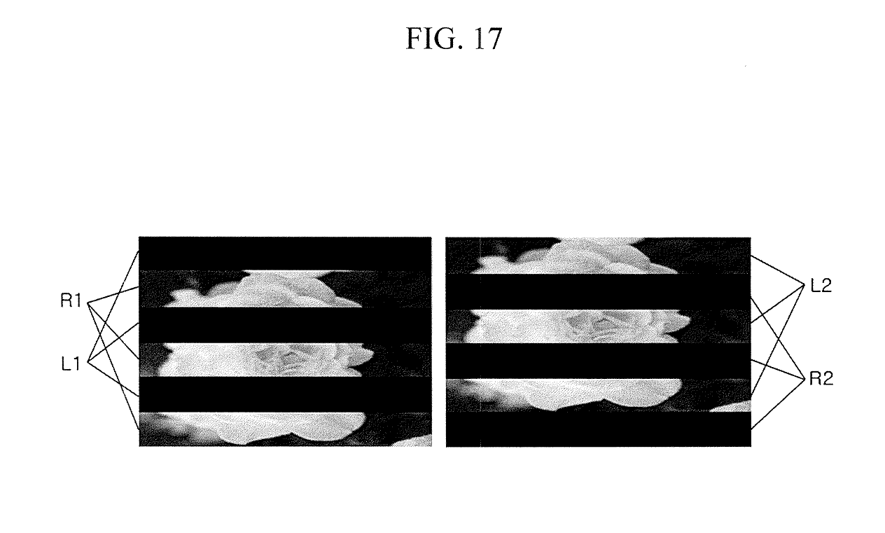

FIG. 16 illustrates an exemplary embodiment in which a main image and a sub image are displayed using a side-by-side method, and FIG. 17 illustrates an exemplary embodiment in which a main image and a sub image are displayed using a top-and-bottom method.

In FIGS. 16 and 17, in images on the left, a left eye image L1 is a sub image and a right eye image R1 is a main image, and in images on the right, a left eye image L2 is a main image and a right eye image R2 is a sub image. The left eye image L1 and the right eye image R1 on the left are images generated based on the same image information and having no disparity therebetween. The left eye image L1 is sub image processed, and the left eye image L1 and the right eye image R1 are alternately displayed using the side-by-side method or the top-and-bottom method. The left eye image L2 and the right eye image R2 on the right are images generated based on the same image information and having no disparity therebetween. The right eye image R2 is sub image processed, and the left eye image L2 and the right eye image R2 are alternately displayed using the side-by-side method or the top-and-bottom method.

By setting a period to be indicated on the left of each drawing and a period to be indicated on the right of each drawing, the anisometropia mode may be set to any one of a right eye main view mode, a left eye main view mode, a self-diagnosis mode, or the like.

Even though FIGS. 16 and 17 illustrate an example in which a sub image is a black image, the sub image may be, as described above, a single color image including a gray image in addition to the black image, or an image having no disparity with a main image and converted based on the main image (for example, a blurred image, a silhouette image, and a resolution-reduced image). In the case of the main image and the sub image simultaneously displayed using an interlace method, the main image may be input to one of the left eye and the right eye, and the sub image may be input to the other one of the left eye and the right eye through a parallax barrier, a lenticular lens, or a combination of a λ/4 retarder and a phase film. The viewer depends on the eye to which the normal image is input to recognize an image and thus, a covering effect of more frequently using the eye to which the main image is input and substantially covering the eye to which the sub image is input may be achieved.

According to the exemplary embodiments of the present invention, a user may treat, prevent, or self-diagnose anisometropia when naturally viewing an image through a display device configured to display a left eye image and a right eye image.

The present invention is not limited to predetermined content or time and may be applied to all of image sources of a display device such as for viewing a moving picture, document work, and Internet surfing, and may also be applied without a restriction on a work environment or a viewing environment.

Although the present invention has been described with reference to exemplary embodiments thereof, it will be understood that various modifications in form and details may be made therein without departing from the spirit and scope of the present invention.

What is claimed is:

1. A display device comprising:
a display panel on which a plurality of pixels is disposed, wherein the display panel is configured to display a left eye image and a right eye image;
a signal processor configured to generate and to output a left eye image signal and a right eye image signal; and
a timing controller configured to control the display panel to display the left eye image and the right eye image based on the left eye image signal and the right eye image signal outputted from the signal processor,
wherein one of the left eye image and the right eye image is a normal image obtained from image information inputted to the signal processor and the other one of the left eye image and the right eye image is a sub image,
wherein the sub image is a single color image or a converted image obtained from the normal image.

2. The display device of claim 1, wherein:
the single color image is a black image or a gray image.

3. The display device of claim 1, wherein:
the converted image is a blurred image, a silhouette image, or a luminance-reduced image.

4. The display device of claim 1, wherein:
the normal image is displayed during a first period, and the sub image is displayed during a second period.

5. The display device of claim 1, wherein:
a length of the first period is between one minute and one hour

6. The display device of claim 4, wherein:
the left eye image is displayed as the normal image during the first period and is displayed as the sub image during the second period, and the right eye image is displayed as the sub image during the first period and is displayed as the normal image during the second period.

7. The display device of claim 6, wherein:
both the left eye image and the right eye image are displayed as the normal image during a third period,
wherein the third period is positioned between the first period and the second period or after the second period.

8. The display device of claim 1, further comprising:
a mode selector configured to output a selection signal corresponding to a display mode in which the display device is to be operated among a two-dimensional (2D) mode, a three-dimensional (3D) mode, and an anisometropia mode.

9. The display device of claim 1, wherein:
the signal processor is included in the timing controller.

10. An method for displaying an image in a display device, the method comprising:
generating and outputting a left eye image signal and a right eye image signal;
controlling an image display of a display panel based on the left eye image signal and the right eye image signal; and
displaying a left eye image and a right eye image on the display panel based on the left eye image signal and the right eye image signal,
wherein one of the left eye image and the right eye image is a normal image obtained from input image information, and the other one of the left eye image and the right eye image is a sub image,
wherein the sub image is a single color image or a converted image obtained from the normal image.

11. The method of claim 10, wherein:
the single color image is a black image or a gray image, and the converted image is a blurred image, a silhouette image, or a luminance-reduced image.

12. The method of claim 10, wherein:
the normal image is displayed in a first period, and the sub image is displayed during a second period.

13. The method of claim 10, wherein:
a length of the first period is between one minute and one hour.

14. The method of claim 12, wherein:
the left eye image is displayed as the normal image during the first period and displayed as the sub image during the second period, and the right eye image is displayed as the sub image during the first period and displayed as the normal image during the second period.

15. The method of claim 14, wherein:
the first period is longer than the second period, and the first period and the second period repeat.

16. The method of claim 15, wherein:
both the left eye image and the right eye image are displayed as the normal image during a third period,
wherein the third period is positioned between the first period and the second period or after the second period, and the first to third periods repeat.

17. The method of claim 14, wherein:
the first period is shorter than the second period, and the first period and the second period repeat.

18. The method of claim 14, wherein:
the length of the first period is identical to that of the second period, and the first period and the second period repeat.

19. A display device comprising:
a display panel on which a plurality of pixels is disposed, wherein the display panel is configured to display a left eye image and a right eye image; and
a signal processor configured to receive image information, and to output a left eye image signal and a right eye image signal for displaying the left eye image and the right eye image,
wherein one of the left eye image and the right eye image is displayed as a normal image for a first period and the other one of the left eye image and the right eye image is displayed as a sub image for a second period, and
wherein the sub image is a version of the normal image that has been modified to be harder to see.

20. The display device of claim 19, wherein:
the signal processor is further configured to display a three-dimensional (3D) image during a 3D mode.
